(19) United States
(12) Patent Application Publication
(10) Pub. No.: US 2021/0032485 A1
(43) Pub. Date: Feb. 4, 2021

(54) AQUEOUS INK JET INK COMPOSITION AND AN INK JET RECORDING METHOD

(71) Applicant: Seiko Epson Corporation, Tokyo (JP)

(72) Inventors: Akiko YAMADA, Shiojiri (JP); Hideki OKADA, Shiojiri (JP); Yumi SUZUKI, Shiojiri (JP)

(21) Appl. No.: 16/942,927

(22) Filed: Jul. 30, 2020

(30) Foreign Application Priority Data
Jul. 31, 2019 (JP) 2019-140791

(51) Int. Cl. C09D 11/322; C08L 75/04; C08K 5/00; D06P 5/30

(52) U.S. Cl. CPC C09D 11/322; C08L 75/04; C08K 5/0041; C08L 2201/54; D06P 5/30; C08K 2201/003; C08L 2205/18; C08K 5/005

(57) ABSTRACT

An aqueous ink jet ink composition includes an organic fluorescent pigment; ionic resin particles; a water-soluble organic solvent; and water, and when the organic fluorescent pigment and the ionic resin particles are collectively regarded as a dispersion component, the dispersion component has a volume average particle diameter (D50_{T}) of 150.0 nm or less.

The present application is based on, and claims priority from JP Application Serial Number 2019-140791, filed Jul. 31, 2019, the disclosure of which is hereby incorporated by reference herein in its entirety.

### BACKGROUND

### 1. Technical Field

The present disclosure relates to an aqueous ink jet ink composition and an ink jet recording method.

### 2. Related Art

In order to record an image by an ink jet method, various types of aqueous ink jet ink compositions have been used. In general, an aqueous ink jet ink composition contains a colorant in order to obtain an image having a desired color.

In recent years, in order to respond to requirements from many various types of designs for sport wears and the like, needs to print fluorescent colors by digital printing have been increasingly in demand. As a fluorescent ink for ink jet printing, in general, a dye has been used. As a pigment, for example, JP-A-2009-161688 has disclosed a fluorescent pigment containing a vinyl copolymer dyed with a fluorescent dye. In addition, JP-A-2001-226595 has disclosed fluorescent resin fine particles which are formed of resin particles containing an organic fluorescent substance and which have an average particle diameter of 90 nm or less.

The fluorescent pigment disclosed in JP-A-2009-161688 is formed from the dye using the resin so as to have a pigment-like property. Hence, a coloring performance per unit area is low as compared to that of a dye or a pigment. In addition, as the particles disclosed in JP-A-2001-226595, when the particle diameter is excessively decreased, the specific surface area is increased, and as a result, a light resistance is more seriously degraded due to the characteristics of the dye. Furthermore, when a fluorescent pigment having an excessively small particle diameter is used for an aqueous ink jet ink composition, a coloring property is improved due to an increase in specific surface area; however, when a recording medium has an ink absorbing property, the fluorescent pigment is not able to stay on a surface of the recording medium and is liable to penetrate therein, and as a result, the coloring property at a surface of a recorded matter is insufficient.

Accordingly, in an aqueous ink jet ink composition using a fluorescent pigment, it is preferable that, compared to a general pigment, a fluorescent pigment having a large particle diameter be used at a high concentration. However, when a fluorescent pigment having a large particle diameter is blended in an aqueous ink jet ink composition at a high concentration, dispersion stability is degraded. Hence, in the aqueous ink jet ink composition using a fluorescent pigment, the dispersion stability and the coloring property are required to be simultaneously obtained.

### SUMMARY

According to an aspect of the present disclosure, there is provided an aqueous ink jet ink composition which comprises: an organic fluorescent pigment; ionic resin particles; a water-soluble organic solvent; and water. In the aqueous ink jet ink composition described above, the organic fluorescent pigment and the ionic resin particles are collectively regarded as a dispersion component, and the dispersion component has a volume average particle diameter (D50_{T}) of 150.0 nm or less.

The aqueous ink jet ink composition described above may be used for printing of a cloth.

In the aqueous ink jet ink composition described above, a content of the organic fluorescent pigment with respect to a total mass of the composition may be 3.0 percent by mass or more.

In any one of the aqueous ink jet ink compositions described above, the dispersion component may have a volume average particle diameter (D50_{T}) of 50.0 nm or more.

In any one of the aqueous ink jet ink compositions described above, the organic fluorescent pigment may have a volume average particle diameter (D50_{P}) of 50.0 to 150.0 nm.

In any one of the aqueous ink jet ink compositions described above, (D50_{R})/(D50_{P}) may be 0.5 to 1.5, and in the above formula, (D50_{R}) represents a volume average particle diameter of the ionic resin particles, and (D50_{P}) represents a volume average particle diameter of the organic fluorescent pigment.

In any one of the aqueous ink jet ink compositions described above, the organic fluorescent pigment may integrally contain a fluorescent dye and a resin.

Any one of the aqueous ink jet ink compositions described above may further comprise an ultraviolet absorber.

In any one of the aqueous ink jet ink compositions described above, a content of the organic fluorescent pigment with respect to a total mass of the composition may be 5.0 to 10.0 percent by mass.

In any one of the aqueous ink jet ink compositions described above, a content of the ionic resin particles with respect to a total mass of the composition may be 6.0 to 12.0 percent by mass.

In any one of the aqueous ink jet ink compositions described above, a content of the dispersion component with respect to a total mass of the composition may be 8.0 to 20.0 percent by mass.

According to another aspect of the present disclosure, there is provided an ink jet recording method which comprises: an ink adhesion step of ejecting an aqueous ink jet ink composition from a nozzle of an ink jet head to adhere to a recording medium. In the ink jet recording method described above, the aqueous ink jet ink composition includes an organic fluorescent pigment, ionic resin particles, a water-soluble organic solvent, and water; the organic fluorescent pigment and the ionic resin particles are collectively regarded as a dispersion component; and the dispersion component has a volume average particle diameter (D50_{T}) of 150.0 nm or less.

### DESCRIPTION OF EXEMPLARY EMBODIMENTS

Hereinafter, embodiments of the present disclosure will be described. In the following embodiments, examples of the present disclosure will be described. The present disclosure is not limited to the following embodiments, and various modified examples to be performed without departing from the scope of the present disclosure may also be included as the embodiments. In addition, all the structures which will be described below are not always required to be essential structures of the present disclosure.

### 1. Aqueous Ink Jet Ink Composition

An aqueous ink jet ink composition of this embodiment comprises: an organic fluorescent pigment, ionic resin particles, a water-soluble organic solvent, and water. In the aqueous ink jet ink composition described above, the organic fluorescent pigment and the ionic resin particles are collectively regarded as a dispersion component, and the dispersion component has a volume average particle diameter (D50_{T}) of 150.0 nm or less.

Incidentally, the volume average particle diameter (D50) is a value to be measured by a particle size distribution meter (such as NanotracWave II-EX150, manufactured by MicrotracBEL Corp.) using a dynamic light scattering method as a measurement principle. In addition, “D50” indicates a median diameter, and when the distribution (cumulative distribution) of particle diameters of a powder is divided into two sections at a certain particle diameter so that the cumulative frequency at a large side is equal to that at a small side, this certain particle diameter is the median diameter. In addition, in this specification, by suffixes “T”, “P”, and “R” added to “D50”, “D50_{T}”, “D50_{R}”, and “D50_{R}” represent D50 of the total dispersion component contained in the aqueous ink jet ink composition, D50 of the organic fluorescent pigment, and D50 of the ionic resin particles, respectively.

### 1.1. Organic Fluorescent Pigment

The aqueous ink jet ink composition includes an organic fluorescent pigment. As the organic fluorescent pigment, for example, there may be mentioned resin particles dyed with a dye, resin particles impregnated with an oil-soluble dye, resin particles obtained by emulsion polymerization under the presence of a dye, or resin particles obtained by pulverizing a resin prepared by a bulk polymerization or the like. That is, the organic fluorescent pigment preferably integrally contains a fluorescent dye and a resin.

Although the organic fluorescent pigment used in the aqueous ink jet ink composition of this embodiment is a daylight fluorescent pigment, the type thereof is not particularly limited, and in addition, the type, the color, and the like of the fluorescent dye contained in the organic fluorescent pigment are also not particularly limited.

As a commercially available product of the organic fluorescent pigment, for example, there may be mentioned SF-3017N, SF-5017, SF-8017, or SW-117 (trade name, manufactured by Sinloihi Co., Ltd.), or NKW-3200E or NKW-3900E (trade name, manufactured by D&C Commercial Co., Ltd.). In addition, there may also be used an organic fluorescent pigment which is obtained such that after those commercially available products are mixed together, a classification treatment is performed to adjust a particle diameter distribution.

The volume average particle diameter (D50_{P}) of the organic fluorescent pigment is not particularly limited as long as the volume average particle diameter (D50_{T}) of the dispersion component included in the aqueous ink jet ink composition is adjusted to 150.0 nm or less. However, the volume average particle diameter (D50_{P}) of the organic fluorescent pigment is preferably 5.0 to 1,000.0 nm, more preferably 30.0 to 700.0 nm, and further preferably 50.0 to 150.0 nm. When the volume average particle diameter (D50_{P}) of the organic fluorescent pigment is set in the range as described above, the volume average particle diameter (D50_{T}) of the dispersion component included in the aqueous ink jet ink composition can be easily adjusted to 150.0 nm or less. When the volume average particle diameter (D50_{P}) of the organic fluorescent pigment is not less than the lower limit described above, the coloring property and the light resistance can be improved, and when the volume average particle diameter (D50_{P}) of the organic fluorescent pigment is not more than the upper limit described above, it is preferable since the dispersion stability tends to be improved. In particular, when the organic fluorescent pigment integrally contains a dye, although the hue is clear, the light resistance may be inferior in some cases; however, when the volume average particle diameter (D50_{P}) of the organic fluorescent pigment is set to 50.0 nm or more, the light resistance is improved.

Although being described later in Examples, D50_{R} of the organic fluorescent pigment has a strong influence on D50_{T} of the dispersion component as compared to D50_{R} of the ionic resin particles. Hence, the volume average particle diameter (D50_{P}) of the organic fluorescent pigment is particularly preferably set to 150.0 nm or less.

The content of the organic fluorescent pigment with respect to the total mass of the aqueous ink jet ink composition is 2.0 to 12.0 percent by mass, preferably 2.5 to 11.0 percent by mass, more preferably 3.0 to 10.0 percent by mass, even more preferably 5.0 to 10.0 percent by mass, and further preferably 5.0 to 8.0 percent by mass. When the content of the organic fluorescent pigment is in the range as described above, while a storage stability is preferably maintained, a preferable coloring property can be obtained.

### 1.2. Ionic Resin Particles

The aqueous ink jet ink composition of this embodiment includes ionic resin particles. Although the ionic resin particles may be either anionic or cationic, the organic fluorescent pigment is anionic in many cases, and from this point of view, the ionic resin particles are more preferably anionic. When the organic fluorescent pigment and the ionic resin particles are both anionic, an electrostatic repulsion is obtained, and as a result, the dispersion stability may be further improved in some cases. In addition, the anionic resin particle indicates a resin particle having a negative zeta potential at a pH of 6.

The ionic resin particles have a function to improve the dispersion stability of the organic fluorescent pigment in the aqueous ink jet ink composition, and in addition, when the aqueous ink jet ink composition is adhered to a recording medium, such as a cloth, having an ink permeability, the ionic resin particles also have a function to allow the organic fluorescent pigment to stay on a surface of the recording medium. In particular, by the latter function, the organic fluorescent pigment is suppressed from penetrating in the recording medium, and when a recorded matter (printed matter) is formed, the coloring property at the surface of the recording medium can be improved. The reason the ionic resin particles have the functions as described above has been believed that the ionic resin particles enhance an aggregation property of the organic fluorescent pigment at the surface of the recording medium.

The ionic resin particles are particles at least containing a polymer formed of a unit derived from a monomer having an ionic group. As the ionic group, for example, there may be mentioned a carboxy group, a sulfonic acid group, a phosphoric acid group, a hydroxy group, or an amino group, and at least one selected from the group consisting of a carboxy group, a sulfonic acid group, and a phosphoric acid group is preferable. The monomer may have either one type of ionic group or at least two types of ionic groups.

The ionic resin particles may be obtained by polymerization, such as suspension polymerization or emulsion polymerization, using the monomer having an ionic group together with, if needed, another monomer. As a commercially available product of the ionic resin particles, for example, there may be mentioned Takelac W-605, W635, WS-6021, W6010, W-6020, or W-6110 (trade name, manufactured by Mitsui Chemicals Inc.), Superflex 460, 470, 610, 700, 740, or 800 (trade name, manufactured by DKS Co., Ltd.), or Mowinyl 952A (trade name, manufactured by The Nippon Synthetic Chemical Industry Co., Ltd.).

The volume average particle diameter (D50_{R}) of the ionic resin particles is not particularly limited as long as the volume average particle diameter (D50_{T}) of the dispersion component included in the aqueous ink jet ink composition is set to 150.0 nm or less. However, the volume average particle diameter (D50_{R}) of the ionic resin particles is preferably 10.0 to 1,000.0 nm, more preferably 30.0 to 700.0 nm, and further preferably 70.0 to 300.0 nm. When the volume average particle diameter (D50_{R}) of the ionic resin particles is set in the range as described above, the volume average particle diameter (D50_{T}) of the dispersion component included in the aqueous ink jet ink composition can be easily set to 150.0 nm or less.

Although being described later in Examples, D50_{R} of the ionic resin particles is not likely to influence on D50_{T} of the dispersion component as compared to D50_{P} of the organic fluorescent pigment. Hence, the volume average particle diameter (D50_{R}) of the ionic resin particles may have a high upper limit of the particle diameter, such as 300.0 nm or less, as compared to that of D50_{P} of the organic fluorescent pigment.

The content of the ionic resin particles with respect to the total mass of the composition is preferably 5.0 to 15.0 percent by mass and more preferably 6.0 to 12.0 percent by mass. When the content of the ionic resin particles is in the range as described above, the storage stability, abrasion resistance, and coloring property can be improved.

### 1.3. Relationship in Particle Diameter Between Organic Fluorescent Pigment and Ionic Resin Particles

A ratio of the volume average particle diameter (D50_{P}) of the ionic resin particles to the volume average particle diameter (D50_{P}) of the organic fluorescent pigment, that is, (D50_{R})/(D50_{P}), is 0.5 to 3.5, preferably 0.5 to 2.0, and more preferably 0.5 to 1.5. When (D50_{P})/(D50_{P}) is set in the range as described above, the volume average particle diameter (D50_{T}) of the dispersion component can be easily set to 150.0 nm or less, and the dispersion stability can be further improved.

When the value of (D50_{P})/(D50_{P}) is in the range described above, since the particle diameter of the organic fluorescent pigment is closer to that of the ionic resin particles, the storage stability of the aqueous ink jet ink composition is further improved. The reason for this is believed that since the particle diameter of the organic fluorescent pigment is closer to that of the ionic resin particles, the organic fluorescent pigment is likely to function as a spacer between the ionic resin particles, the ionic resin particles are suppressed from being brought into contact with each other, and as a result, the aggregation of the ionic resin particles is suppressed.

### 1.4. Water-Soluble Organic Solvent

The aqueous ink jet ink composition of this embodiment includes a water-soluble organic solvent. As the function of the water-soluble organic solvent, for example, to improve a wettability of the aqueous ink jet ink composition to a recording medium and/or to increase a moisture retention property of the aqueous ink jet ink composition may be mentioned. As the water-soluble organic solvent, for example, there may be mentioned an ester, an alkylene glycol ether, a cyclic ester, a nitrogen-containing solvent, or a polyvalent alcohol. As the nitrogen-containing solvent, for example, a cyclic amide or a non-cyclic amide may be mentioned. As the non-cyclic amide, for example, an alkoxyalkyl amide may be mentioned.

As the ester, for example, there may be mentioned a glycol monoacetate, such as ethylene glycol monomethyl ether acetate, ethylene glycol monoethyl ether acetate, ethylene glycol monobutyl ether acetate, diethylene glycol monoethyl ether acetate, diethylene glycol monoethyl ether acetate, diethylene glycol monobutyl ether acetate, propylene glycol monomethyl ether acetate, dipropylene glycol monoethyl ether acetate, or methoxy butyl acetate; or a glycol diester, such as ethylene glycol diacetate, diethylene glycol diacetate, propylene glycol diacetate, dipropylene glycol diacetate, ethylene glycol acetate propionate, ethylene glycol acetate butyrate, diethylene glycol acetate butyrate, diethylene glycol acetate propionate, diethylene glycol acetate butyrate, propylene glycol acetate propionate, propylene glycol acetate butyrate, dipropylene glycol acetate butyrate, or dipropylene glycol acetate propionate.

As the alkylene glycol ether, a monoether or a diether of an alkylene glycol may be used, and an alkyl ether is preferable. As a particular example, for example, there may be mentioned an alkylene glycol monoalkyl ether, such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, or tripropylene glycol monobutyl ether; or an alkylene glycol dialkyl ether, such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, or tripropylene glycol dimethyl ether.

As the cyclic ester, for example, there may be mentioned a cyclic ester (a lactone), such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nonalactone, ε-nonalactone, or ε-decanolactone, or a compounds in which a hydrogen of a methylene group adjacent to a carbonyl group thereof is substituted with an alkyl group having 1 to 4 carbon atoms.

As the alkoxyalkyl amide, for example, there may be mentioned 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, or 3-tert-butoxy-N,N-methylethylpropionamide.

As the cyclic amide, a lactam may be mentioned, and for example, there may be mentioned a pyrrolidone, such as 2-pyrrolidone, 1-methyl-2-pyrrolidone, 1-ethyl-2-pyrrolidone, 1-propyl-2-pyrrolidone, or 1-butyl-2-pyrrolidone.

As the polyvalent alcohol, for example, there may be mentioned a 1,2-alkanediol (an alkanediol, such as ethylene glycol, propylene glycol (alias: propane-1,2-diol), 1,2-butanediol, 1,2-pentanediol, 1,2-hexanediol, 1,2-heptanediol, or 1,2-octanediol) or a polyvalent alcohol (a polyol) excluding the 1,2-alkanediol (such as diethylene glycol, dipropylene glycol, triethylene glycol, 1,3-propanediol, 1,3-butanediol (alias: 1,3-butylene glycol), 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylol propane, or glycerin).

The aqueous ink jet ink composition may use only one type of water-soluble organic solvent or at least two types of water-soluble organic solvents in combination. In addition, the content of the water-soluble organic solvents with respect to the total mass of the aqueous ink jet ink composition is, for example, 5.0 to 50.0 percent by mass, preferably 10.0 to 40.0 percent by mass, more preferably 15.0 to 30.0 percent by mass, and further preferably 15.0 to 20.0 percent by mass. Since the content of the water-soluble organic solvent is in the range described above, the balance between a wet-spreading property and a drying property of the aqueous ink jet ink composition is further improved, and an image having a more excellent quality is likely to be formed.

### 1.5. Water

The aqueous ink jet ink composition according to this embodiment includes water. The “aqueous” indicates a composition including water as one of major solvent components. Water may be contained as a primary solvent component and is a component to be evaporated and scattered by drying. As the water, purified water, such as ion-exchanged water, ultrafiltration water, reverse osmosis water, or distilled water, or water, such as ultra purified water, from which ionic impurities are removed as much as possible is preferable. In addition, when the aqueous ink jet ink composition is stored for a long time, water sterilized by UV irradiation or addition of hydrogen peroxide is preferably used since generation of fungi and/or bacteria can be suppressed. The content of the water with respect to the total mass of the aqueous ink jet ink composition is preferably 40 percent by mass or more, more preferably 50 to 98 percent by mass, and further preferably 55 to 95 percent by mass.

### 1.6. Dispersion Component

In the aqueous ink jet ink composition of this embodiment, the dispersion component indicates the total of components which are not dissolved. Although the organic fluorescent pigment and the ionic resin particles are the components which are not dissolved, it is assumed that the components which are not dissolved described above also include at least one component which is unintentionally generated or mixed therein and is then suspended.

The volume average particle diameter (D50_{T}) of the dispersion component is 150.0 nm or less. Since the volume average particle diameter (D50_{T}) of the dispersion component is 150.0 nm or less, the dispersion stability is preferable. Although D50_{T} of the dispersion component may be adjusted primarily by D50_{R} of the organic fluorescent pigment and D50_{R} of the ionic resin particles, D50_{T} of the dispersion component is not simply obtained as the average therebetween. That is, D50_{T} of the dispersion component is dependent on the particle diameter distribution, the number of particles, the concentration, and the intensity of dynamic light scattering of each of the organic fluorescent pigment and the ionic resin particles.

The volume average particle diameter (D50_{T}) of the dispersion component is preferably 50.0 nm or more. When the volume average particle diameter (D50_{T}) of the dispersion component is 50.0 nm or more, the coloring property and the light resistance are preferable.

The content of the dispersion component with respect to the total mass of the composition is preferably 8.0 to 20.0 percent by mass, more preferably 8.0 to 18.0 percent by mass, and further preferably 10.0 to 18.0 percent by mass. When the content of the dispersion component is in the range as described above, the coloring property and the storage stability can be made preferable.

### 1.7. Other Components

The aqueous ink jet ink composition of this embodiment may include, besides the components described above, the following components.

### 1.7.1. Ultraviolet Absorber

The aqueous ink jet ink composition of this embodiment may include an ultraviolet absorber. Since the ultraviolet absorber is included, the light resistance of a recorded matter can be significantly improved. In particular, when the organic fluorescent pigment integrally contains a fluorescent dye and a resin, the light resistance is liable to be degraded; however, since the ultraviolet absorber is included, the light resistance is improved.

As the ultraviolet absorber, for example, there may be mentioned a compound containing, as a primary component, a hydroxyphenyltriazine-based compound, a benzophenone-based compound, a benzotriazole-based compound, a cyanoacrylate-based compound, zinc oxide, cerium oxide, or rutile-type titanium oxide. In this embodiment, in order to decrease the viscosity, and in view of the storage stability and the ejection stability, an organic ultraviolet absorber is preferable, and in particular, a benzophenone-based compound, a benzotriazole-based compound, or a cyanoacrylate-based compound is preferably used.

As a commercially available product of the ultraviolet absorber, for example, there may be mentioned SEESORB 101, 1015, 102, 103, 106, 107, 151, 201, 202, 501, 502, 612NH, 701, 703, 707, or 709 (trade name, manufactured by SHIPRO KASEI KAISHA, LTD.); or KEMISORB 71, 73, 74, 79, 279, 10, 11, 11S, 12, or 111 (trade name, manufactured by Chemipro Kasei Kaisha, Ltd); or Shineguard TA-04 (trade name, manufactured by SENKA Corporation).

When the ultraviolet absorber is used, the lower limit of the content thereof with respect to the total mass of the ink jet ink is preferably 0.05 percent by mass or more, more preferably 0.1 percent by mass or more, and further preferably 0.5 percent by mass or more. On the other hand, the upper limit of the content of the ultraviolet absorber with respect to the total mass of the ink jet ink is preferably 6 percent by mass or less, more preferably 5 percent by mass or less, and further preferably 4 percent by mass or less.

### 1.7.2. Surfactant

The aqueous ink jet ink composition according to this embodiment may include a surfactant. The surfactant may be used to decrease the surface tension of the aqueous ink jet ink composition and to adjust and/or improve the wettability (penetration property to a cloth or the like) to a recording medium. As the surfactant, at least one selected from a silicone compound, a fluorine compound, an acetylene glycol compound, and a polyoxyethylene compound is preferably used. In addition, in this specification, a silicone compound, a fluorine compound, an acetylene glycol compound, and a polyoxyethylene compound are collectively called “surfactant”.

Although the silicone compound is not particularly limited, a polysiloxane-based compound may be used. As the polysiloxane compound, for example, a polyether-modified organosiloxane may be mentioned. As a commercially available products of the polyether-modified organosiloxane, for example, there may be mentioned BYK-028, BYK-306, BYK-307, BYK-333, BYK-341, BYK-345, BYK-346, BYK-347, BYK-348, or BYK-349 (trade name, manufactured by BYK Japan KK); KF-351A, KF-352A, KF-353, KF-354L, KF-355A, KF-615A, KF-945, KF-640, KF-642, KF-643, KF-6020, X-22-4515, KF-6011, KF-6012, KF-6015, or KF-6017 (trade name, manufactured by Shin-Etsu Chemical Co., Ltd.); or Silface SAG002, 005, 503A, or 008 (trade name, manufactured by Nisshin Chemical Industry Co., Ltd.).

Although the fluorine compound is not particularly limited, for example, a perfluoroalkyl sulfonate salt, a perfluoroalkyl carbonate salt, a perfluoroalkyl phosphate ester, a perfluoroalkyl ethylene oxide adduct, a perfluoroalkyl betaine, a perfluoroalkylamine oxide compound, or a fluorine-modified polymer. As a commercially available product thereof, for example, there may be mentioned S-144 or S-145 (trade name, manufactured by Asahi Glass Co., Ltd.); FC-170C, FC-430, or Florad FC4430 (trade name, manufactured by Sumitomo 3M Limited); FSO, FSO-100, FSN, FSN-100, or FSN-300 (trade name, manufactured by Dupont); FT-250 or FT-251 (trade name, manufactured by Neos Co., Ltd.); or BYK-340 (trade name, manufactured by BYK Japan KK).

Although the acetylene glycol compound is not particularly limited, for example, there may be mentioned Surfynol 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, or DF110D, or Dynol 604 or 607 (trade name, manufactured by Air Products and Chemicals, Inc.); Olfine B, Y, P, A, STG, SPC, E1004, E1010, E1020, PD-001, PD-002W, PD-003, PD-004, PD-005, EXP.4001, EXP.4036, EXP.4051, EXP.4123, EXP.4200, EXP.4300, AF-103, AF-104, AK-02, SK-14, or AE-3 (trade name, manufactured by Nisshin Chemical Industry Co., Ltd.); or Acetylenol E00, E00P, E40, E60, or E100 (trade name, manufactured by Kawaken Fine Chemicals Co., Ltd.).

Although the polyoxyethylene compound is not particularly limited, for example, there may be mentioned Newcol 2300 series (such as 2303, 2327, or 2399-S), Newcol NT series (such as 3, 5, 7, or 9), Newcol 1000 series (such as 1004, 1006, 1008, 1203, 1305, or 1525) (trade name, manufactured by Nippon Nyukazai Co., Ltd.); Emulgen 102KG, 103, 104P, 105, 106, 108, 120, 147, 150, 220, 350, 404, 420, 430, 705, 707, 709, 1108, 4085, or 2025G (trade name, manufactured by Kao Corporation); or a polyoxyethylene alkyl ether compound, such as a polyoxyethylene polyoxypropylene hexyl ether (C₆H₁₃-EO—PO—OH).

When the surfactant is used, at least one type may be used, or at least two types may be used in combination. Since the surfactant as described above is added to the aqueous ink jet ink composition, while foaming is suppressed, the surface tension can be reduced. Accordingly, the wettability to a recording medium, such as a cloth, is improved, and as a result, an image or a pattern can be clearly printed. The content of the surfactant with respect to the total mass of the ink composition is, for example, preferably 0.05 to 5 percent by mass, more preferably 0.1 to 5 percent by mass, and further preferably 0.2 to 4 percent by mass.

In addition, since the aqueous ink jet ink composition includes the surfactant, when the ink is ejected from a head, the stability tends to be improved. In addition, when an appropriate amount of the surfactant is used, the penetration property to a cloth is improved, and as a result, the contact with a pre-treatment composition may be increased in some cases.

### 1.7.3. pH Adjuster

In order to adjust pH, a pH adjuster may be added to the ink composition of this embodiment. Although the pH adjuster is not particularly limited, for example, appropriate combination among an acid, a base, a weak acid, and a weak base may be mentioned. As examples of the acid and the base to be used for the combination described above, for example, there may be mentioned sulfuric acid, hydrochloric acid, or nitric acid as an inorganic acid; lithium hydroxide, sodium hydroxide, potassium hydroxide, potassium dihydrogen phosphate, disodium hydrogen phosphate, potassium carbonate, sodium carbonate, sodium hydrogen carbonate, or ammonia as an inorganic base; triethanolamine, diethanolamine, monoethanolamine, tripropanolamine, triisopropanolamine, diisopropanolamine, or tris(hydroxymethyl)aminomethane (THAM) as an organic base; or adipic acid, citric acid, succinic acid, or lactic acid as an organic acid. In addition, as a buffer solution, there may be used a good buffer, such as N,N-bis(2-hydroxyethyl)-2-aminoethane sulfonic acid (BES), 4-(2-hydroxyethyl)-1-piperadineethane sulfonic acid (HEPES), morpholinoethane sulfonic acid (MES), carbamoylmethyl iminobisacetic acid (ADA), piperazine-1,4-bis(2-ethanesulfonic acid) (PIPES), N-(2-acetamide)-2-aminoethane sulfonic acid (ACES), cholamine chloride, N-tris(hydroxymethyl)methyl-2-aminoethane sulfonic acid (TES), acetamide glycine, tricine, glycine amide, or bicine; a phosphoric acid buffer solution, a citric acid buffer solution, or a tris buffer solution. Furthermore, since a pH buffer effect can be more stably obtained, as a part or the whole of the pH adjuster, among those mentioned above, a tertiary amine, such as triethanolamine or triisopropanolamine, or a carboxy group-containing organic acid, such as adipic acid, citric acid, a succinic acid, or lactic acid is preferably contained.

### 1.7.4. Urea

As the moisture retention agent for the aqueous ink jet ink composition, or as a dyeing auxiliary agent therefor to improve a dying property of a dye, an urea may also be used. As a particular example of the urea, for example, there may be mentioned urea, ethyleneurea, tetramethylurea, thiourea, or 1,3-dimethyl-2-imidazolidinone. When an urea is contained, the content thereof with respect to the total mass of the ink composition may be set to 1 to 10 percent by mass.

### 1.7.5. Sugar

In order to suppress solidification and drying of the aqueous ink jet ink composition, a sugar may also be used. As a particular example of the sugar, for example, there may be mentioned glucose, mannose, fructose, ribose, xylose, arabinose, galactose, aldonic acid, glucitol (sorbit), maltose, cellobiose, lactose, sucrose, trehalose, or maltotriose.

### 1.7.6. Chelating Agent

In order to remove unnecessary materials in the aqueous ink jet ink composition, a chelating agent may also be used. As the chelating agent, for example, there may be mentioned ethylenediaminetetraacetic acid or its salt (such as dihydrogen disodium ethylenediaminetetraacetate, or a nitrilotriacetate salt, a hexametaphosphate salt, a pyrophosphate salt, or a metaphosphate salt of ethylenediamine).

### 1.7.7. Antiseptic Agent and Fungicide,

For the aqueous ink jet ink composition, an antiseptic agent and/or a fungicide may also be used. As the antiseptic agent and/or the fungicide, for example, there may be mentioned sodium benzoate, sodium pentachlorophenol, sodium 2-pyridinethiol-1-oxide, sodium sorbate, or sodium dehydroacetate; Proxel CRL, Proxel BDN, Proxel GXL, Proxel XL-2, Proxel IB, or Proxel TN (trade name, manufactured by Lonza Japan); or 4-chloro-3-methylphenol (such as Perventol CMK, manufactured by Bayer AG).

### 1.7.8 Antirust Agent

For the aqueous ink jet ink composition, an antirust agent may also be used. As a preferable example of the antirust agent, for example, benzotriazole, acidic sulfite, sodium thiosulfate, ammonium thioglycolate, diisopropyl ammonium nitrite, pentaerythritol tetranitrate, or dicyclohexyl ammonium nitrite may be mentioned. Among those mentioned above, in particular, benzotriazole is preferable.

### 1.7.9. Others

As components other than those described above, for example, additives, such as an antioxidant, an oxygen absorber, and/or a solubility agent, each of which may be generally used for an ink jet ink composition, may also be contained.

### 1.8. pH of Aqueous Ink Jet Ink Composition

The pH of the aqueous ink jet ink composition of this embodiment is 5.8 to 10.5, preferably 6.0 to 10.0, more preferably 6.0 to 9.5, and further preferably 7.0 to 8.5. When the pH of the aqueous ink jet ink composition is in the range described above, since storage stability of a dye in the ink composition is improved, and the coloring property and the hue of an image to be obtained are not likely to change, a predetermined designed color can be preferably reproduced.

The pH of the aqueous ink jet ink composition can be adjusted in the range described above, for example, by adjusting at least one of the type of counter ion of the ionic resin particles, the balance therebetween, the selection of the type of pH adjuster, and the addition amount thereof.

### 1.9. Production of Aqueous Ink Jet Ink Composition and Physical Properties Thereof

The aqueous ink jet ink composition according to this embodiment may be obtained by mixing the components described above in an arbitrary order, followed by, if needed, removing impurities by filtration or the like. As a mixing method of the components, a method in which raw materials are sequentially added in a container equipped with a stirring device, such as a mechanical stirrer or a magnetic stirrer, and are then stirred and mixed may be preferably used.

In view of the balance between printing quality and reliability as the ink jet printing ink, the surface tension of the aqueous ink jet ink composition according to this embodiment is preferably 20 to 40 mN/m and more preferably 22 to 35 mN/m. In addition, in the same view as described above, the viscosity of the ink composition at 20° C. is preferably 1.5 to 10 mPa·s and more preferably 2 to 8 mPa·s. In order to set the surface tension and the viscosity in the ranges described above, the types of the water-soluble solvent and the surfactant, the addition amounts thereof, the addition amount of water, and the like may be appropriately adjusted.

### 1.10. Operational Effect

According to the aqueous ink jet ink composition of this embodiment, even in the system in which the organic fluorescent pigment is used, the dispersion stability can be preferably maintained primarily by the function of the ionic resin particles. Accordingly, an organic fluorescent pigment having a relatively large particle diameter can be easily used, and in addition, the concentration of the organic fluorescent pigment can be easily increased. Since the particle diameter of the organic fluorescent pigment is large, for example, penetration thereof into a cloth to which printing is to be performed can be suppressed, and hence, the organic fluorescent pigment is easily disposed on the surface of the cloth, so that preferable coloration can be easily obtained. Furthermore, since the concentration of the organic fluorescent pigment can be increased, a preferable coloring property can be easily obtained. In addition, according to the aqueous ink jet ink composition of this embodiment, since the volume average particle diameter of the dispersion component is 150.0 nm or less, the dispersion stability is also preferable.

### 2. Ink Jet Recording Method

An ink jet recording method of this embodiment comprises a step of adhering the aqueous ink jet ink composition described above to a recording medium. An ink jet recording apparatus which may be used for the ink jet recording method will be described.

The recording medium is not particularly limited, and either a medium having a recording surface which absorbs a liquid or a medium having no recording surface which absorbs a liquid may be used. Hence, the recording medium is not particularly limited, and for example, paper, a film, a cloth, a metal, a glass, or a polymer may be used. When the recording medium has a recording surface which absorbs a liquid, although an organic fluorescent pigment is liable to penetrate into the recording medium, according to the structure of the present disclosure, the coloring property can be preferably improved. When an image is recorded on a cloth, an effect of improving the coloring property is more significant.

The cloth is not particularly limited. A raw material forming the cloth is not particularly limited, and for example, there may be used natural fibers, such as a cotton, a hemp, a wool, or a silk; synthetic fibers, such as a polypropylene, a polyester, an acetate, a triacetate, a polyamide, or a polyurethane; biodegradable fibers, such as a poly(lactic acid); or a blend of those fibers. As the cloth, any one of a woven fabric, a knitted fabric, a non-woven cloth, and the like formed from the fibers described above may be used, or for example, a blended woven fabric may also be used.

### 2.1. Ink Jet Recording Apparatus

As the ink jet recording apparatus, either a serial type or a line type may be used. In each of those types of ink jet recording apparatuses, an ink jet head is mounted, and while a relative positional relationship between a recording medium and the ink jet head is changed, a predetermined volume (mass) of a liquid droplet of an aqueous ink jet ink composition is ejected from a nozzle hole of the ink jet head, so that a predetermined image can be formed on the recording medium by adhesion of the aqueous ink jet ink composition thereto.

In the ink jet recording apparatus used in this embodiment, for example, known structures, such as a dry unit, a roll unit, and/or a winding device, may be arbitrarily used. In addition, in the ink jet recording apparatus, for example, a transport device transporting a recording medium, an image layer forming device recording an image using an aqueous ink jet ink composition, a drying device, and an entire drying device heating a recording surface and sending wind thereto may be provided.

The transport device may be formed, for example, of at least one roller. The transport device may have a plurality of rollers. As long as the recording medium can be transported, the position of the transport device and the number thereof are not particularly limited. The transport device may include a roll mechanism, a tray, and/or various types of platens.

The image layer forming device records an image layer on a recording surface of the recording medium by ejecting the aqueous ink jet ink composition of this embodiment. The image layer forming device includes an ink jet head having nozzles, and nozzle lines are arranged for respective predetermined compositions.

The drying device is used to heat and dry the image layer formed on the recording surface and/or to remove a volatile component on the recording medium. The drying device may be provided at any place in consideration of a timing at which the adhesion step is performed, a transport path of the recording medium, and the like, and the number of the drying devices is not particularly limited. As the image layer drying device, for example, there may be mentioned a method to heat the recording medium by platen heating, a method to blow wind to an image on the recording medium, or a method using the methods described above in combination. In particular, as the device using those methods described above, for example, forced air heating, radiation heating, electric conduction heating, high-frequency drying, or microwave drying may be mentioned.

### 2.2. Steps of Recording Method

The ink jet recording method of this embodiment may include an ink adhesion step of adhering an aqueous ink jet ink composition to a recording medium. The step of adhering an aqueous ink jet ink composition to a recording medium may be performed using the ink jet recording apparatus described above.

In addition, the step of adhering an aqueous ink jet ink composition to a recording medium may be performed at least two times, and the order of the steps and the number thereof are not limited and may be appropriately performed as required. In addition, when a plurality of aqueous ink jet ink compositions is used, the compositions may be adhered to different regions of the recording medium or to the same region thereof.

In addition, the ink jet recording method of this embodiment may appropriately include a step of heating a recording medium. For example, when the ink jet recording apparatus is used, the step of heating a recording medium may be performed by using the drying device described above. In addition, even when the ink jet recording apparatus is not used, the step described above may also be performed using an appropriate drying device. Accordingly, since an image to be obtained can be dried and sufficiently fixed, for example, a recorded matter may be immediately placed in a ready-to-use state.

In the case described above, although the temperature of the recording medium is not particularly limited, the temperature thereof may be set in consideration of, for example, a glass transition temperature (Tg) of a resin component contained in the aqueous ink jet ink composition. When Tg of the resin component is taken into consideration, the temperature may be set lower than Tg of the resin component forming the resin particles by 5° C. or more and preferably by 10° C. or more.

The ink jet recording method of this embodiment may further appropriately include at least one another step, and for example, a step of applying a pre-treatment liquid and/or a washing step may be included.

### 3. Examples and Comparative Examples

Hereinafter, although examples will be described in detail, the present disclosure is not limited to the following examples. Hereinafter, “part(s)” and “%” are each a mass basis unless otherwise particularly noted. In addition, evaluation was performed at a temperature of 25° C. and a relative humidity of 40% unless otherwise specified in particular.

### 3.1. Preparation of Aqueous Ink Jet Ink Composition

The compositions of the aqueous ink jet ink compositions of Examples and Comparative Examples are shown in Tables 1 and 2. The aqueous ink jet ink composition was prepared by mixing and stirring the components shown in each of Tables 1 and 2 for 30 minutes or more, followed by performing filtration. As a mixing method of the components, after being sequentially added in a container equipped with a mechanical stirrer, raw materials were stirred and mixed together. Subsequently, filtration was performed using a filter, so that an aqueous ink jet ink composition of each example (each of Examples 1 to 12 and Comparative Examples 1 to 3) was obtained.

TABLE 1

| | | | EXAMPLE | | | | | | | |
|---|---|---|---|---|---|---|---|---|---|---|
| | | | 1 | 2 | 3 | 4 | 5 | 6 | 7 | 8 |
| AQUEOUS INK | ORGANIC | PIGMENT | 3.50 | — | 2.50 | 6.00 | 8.00 | 8.00 | 6.00 | — |
| JET INK | PIGMENT | DISPERSION | | | | | | | | |
| COMPOSITION | | (1) | | | | | | | | |
| | | PIGMENT | — | 3.50 | — | — | — | — | — | — |
| | | DISPERSION | | | | | | | | |
| | | (2) | | | | | | | | |
| | | PIGMENT | — | — | — | — | — | — | — | 3.50 |
| | | DISPERSION | | | | | | | | |
| | | (3) | | | | | | | | |
| | | PIGMENT | — | — | — | — | — | — | — | — |
| | | DISPERSION | | | | | | | | |
| | | (4) | | | | | | | | |
| | | PIGMENT | — | — | — | — | — | — | — | — |
| | | DISPERSION | | | | | | | | |
| | | (5) | | | | | | | | |
| | IONIC RESIN | RESIN | 5.00 | 5.00 | 5.00 | 5.00 | 5.00 | 10.00 | 5.00 | 5.00 |
| | PARTICLES | PARTICLE | | | | | | | | |
| | | DISPERSION | | | | | | | | |
| | | (1) | | | | | | | | |
| | | RESIN | — | — | — | — | — | — | — | — |
| | | PARTICLE | | | | | | | | |
| | | DISPERSION | | | | | | | | |
| | | (2) | | | | | | | | |
| | | RESIN | — | — | — | — | — | — | — | — |
| | | PARTICLE | | | | | | | | |
| | | DISPERSION | | | | | | | | |
| | | (3) | | | | | | | | |
| | NON-IONIC RESIN PARTICLES | | — | — | — | — | — | — | — | — |
| | WATER- | GLYCERIN | 12.00 | 12.00 | 12.00 | 12.00 | 12.00 | 7.00 | 12.00 | 12.00 |
| | SOLUBLE | TRIETHYLENE | 7.50 | 7.50 | 7.50 | 7.50 | 7.50 | 7.50 | 7.50 | 7.50 |
| | ORGANIC | GLYCOL | | | | | | | | |
| | SOLVENT | TRIETHYLENE | 0.50 | 0.50 | 0.50 | 0.50 | 0.50 | 0.50 | 0.50 | 0.50 |
| | | GLYCOL | | | | | | | | |
| | | MONOBUTYL | | | | | | | | |
| | | ETHER | | | | | | | | |
| | | 2- | 4.00 | 4.00 | 4.00 | 4.00 | 4.00 | 4.00 | 4.00 | 4.00 |
| | | PYRROLIDONE | | | | | | | | |
| | | TRIMETHYLOL- | 3.00 | 3.00 | 3.00 | 3.00 | 3.00 | 3.00 | 3.00 | 3.00 |
| | | PROPANE | | | | | | | | |
| | ULTRAVIOLET ABSORBER | | — | — | — | — | — | — | 0.50 | — |
| | SURFACTANT | BYK348 | 0.30 | 0.30 | 0.30 | 0.30 | 0.30 | 0.30 | 0.30 | 0.30 |
| | | BYK028 | 0.02 | 0.02 | 0.02 | 0.02 | 0.02 | 0.02 | 0.02 | 0.02 |
| | | EMULGEN | 0.10 | 0.10 | 0.10 | 0.10 | 0.10 | 0.10 | 0.10 | 0.10 |
| | CHELATING | EDTA | 0.02 | 0.02 | 0.02 | 0.02 | 0.02 | 0.02 | 0.02 | 0.02 |
| | AGENT | | | | | | | | | |
| | ANTISEPTIC | PROXEL | 0.30 | 0.30 | 0.30 | 0.30 | 0.30 | 0.30 | 0.30 | 0.30 |
| | AGENT | | | | | | | | | |
| | ANTIRUST | BTA | 0.05 | 0.05 | 0.05 | 0.05 | 0.05 | 0.05 | 0.05 | 0.05 |
| | AGENT | | | | | | | | | |
| | PH ADJUSTER | KOH | 0.075 | 0.075 | 0.075 | 0.075 | 0.075 | 0.075 | 0.075 | 0.075 |
| | WATER | ION- | BAL- | BAL- | BAL- | BAL- | BAL- | BAL- | BAL- | BAL- |
| | | EXCHANGED | ANCE | ANCE | ANCE | ANCE | ANCE | ANCE | ANCE | ANCE |
| | | WATER | | | | | | | | |
| | SOLID COMPONENT | | 8.50 | 8.50 | 7.50 | 11.00 | 13.00 | 18.00 | 11.50 | 8.50 |
| | (PIGMENT AND RESIN) | | | | | | | | | |
| PARTICLE | ENTIRE INK | D50T [nm] | 65.93 | 132.2 | 65.93 | 64.43 | 66.33 | 68.23 | 66.13 | 42.50 |
| DIAMETER | (DISPERSION | | | | | | | | | |
| EVALUATION | COMPONENT) | | | | | | | | | |
| | PIGMENT | D50P [nm] | 65.31 | 136.2 | 65.31 | 65.31 | 65.31 | 65.31 | 65.31 | 41.40 |
| | DISPERSION | | | | | | | | | |
| | RESIN | D50R [nm] | 79.10 | 79.10 | 79.10 | 79.10 | 79.10 | 79.10 | 79.10 | 79.10 |
| | PARTICLE | | | | | | | | | |
| | DISPERSION | | | | | | | | | |

| | | | | | | | | | |
|---|---|---|---|---|---|---|---|---|---|
| | D50R/D50P[−] | 1.211 | 1.211 | 1.211 | 1.211 | 1.211 | 1.211 | 1.211 | 1.911 |
| EVALUATION | DISPERSION STABILITY | A | A | A | A | A | A | A | A |
| RESULT | EJECTION PERFORMANCE | A | A | A | A | A | A | A | A |
| | COLORATION | B | B | B′ | A | A | A | A | B |
| | ABRASION RESISTANCE | A/B | A/B | A/B | A/B | A/B | A/A | A/B | A/B |
| | (DRY/WET) | | | | | | | | |
| | LIGHT RESISTANCE | B | B | B | B | B | B | A | B′ |
| | STORAGE STABILITY | A | A | A | A | A | A | A | B |

TABLE 2

| | | | | | | | COMPARATIVE | | |
|---|---|---|---|---|---|---|---|---|---|
| | | | EXAMPLE | | | | EXAMPLE | | |
| | | | 9 | 10 | 11 | 12 | 1 | 2 | 3 |
| AQUEOUS INK | ORGANIC | PIGMENT | 3.50 | 3.50 | 11.00 | 8.00 | — | — | 3.50 |
| JET INK | PIGMENT | DISPERSION | | | | | | | |
| COMPOSITION | | (1) | | | | | | | |
| | | PIGMENT | — | — | — | — | — | — | — |
| | | DISPERSION | | | | | | | |
| | | (2) | | | | | | | |
| | | PIGMENT | — | — | — | — | — | — | — |
| | | DISPERSION | | | | | | | |
| | | (3) | | | | | | | |
| | | PIGMENT | — | — | — | — | 3.50 | — | — |
| | | DISPERSION | | | | | | | |
| | | (4) | | | | | | | |
| | | PIGMENT | — | — | — | — | — | 3.50 | — |
| | | DISPERSION | | | | | | | |
| | | (5) | | | | | | | |
| | IONIC RESIN | RESIN | — | — | 10.00 | 14.00 | 5.00 | 5.00 | — |
| | PARTICLES | PARTICLE | | | | | | | |
| | | DISPERSION | | | | | | | |
| | | (1) | | | | | | | |
| | | RESIN | 5.00 | — | — | — | — | — | — |
| | | PARTICLE | | | | | | | |
| | | DISPERSION | | | | | | | |
| | | (2) | | | | | | | |
| | | RESIN | — | 5.00 | — | — | — | — | — |
| | | PARTICLE | | | | | | | |
| | | DISPERSION | | | | | | | |
| | | (3) | | | | | | | |
| | NON-IONIC RESIN PARTICLES | | — | — | — | — | — | — | 5.00 |
| | WATER- | GLYCERIN | 12.00 | 12.00 | 7.00 | 7.00 | 12.00 | 12.00 | 12.00 |
| | SOLUBLE | TRIETHYLENE | 7.50 | 7.50 | 7.50 | 7.50 | 7.50 | 7.50 | 7.50 |
| | ORGANIC | GLYCOL | | | | | | | |
| | SOLVENT | TRIETHYLENE | 0.50 | 0.50 | 0.50 | 0.50 | 0.50 | 0.50 | 0.50 |
| | | GLYCOL | | | | | | | |
| | | MONOBUTYL | | | | | | | |
| | | ETHER | | | | | | | |
| | | 2- | 4.00 | 4.00 | 4.00 | 4.00 | 4.00 | 4.00 | 4.00 |
| | | PYRROLIDONE | | | | | | | |
| | | TRIMETHYLOL- | 3.00 | 3.00 | 3.00 | 3.00 | 3.00 | 3.00 | 3.00 |
| | | PROPANE | | | | | | | |
| | ULTRAVIOLET ABSORBER | | — | — | — | — | — | — | — |
| | SURFACTANT | BYK348 | 0.30 | 0.30 | 0.30 | 0.30 | 0.30 | 0.30 | 0.30 |
| | | BYK028 | 0.02 | 0.02 | 0.02 | 0.02 | 0.02 | 0.02 | 0.02 |
| | | EMULGEN | 0.10 | 0.10 | 0.10 | 0.10 | 0.10 | 0.10 | 0.10 |
| | CHELATING | EDTA | 0.02 | 0.02 | 0.02 | 0.02 | 0.02 | 0.02 | 0.02 |
| | AGENT | | | | | | | | |
| | ANTISEPTIC | PROXEL | 0.30 | 0.30 | 0.30 | 0.30 | 0.30 | 0.30 | 0.30 |
| | AGENT | | | | | | | | |
| | ANTIRUST | BTA | 0.05 | 0.05 | 0.05 | 0.05 | 0.05 | 0.05 | 0.05 |
| | AGENT | | | | | | | | |
| | PH ADJUSTER | KOH | 0.075 | 0.075 | 0.075 | 0.075 | 0.075 | 0.075 | 0.075 |
| | WATER | ION- | BAL- | BAL- | BAL- | BAL- | BAL- | BAL- | BAL- |
| | | EXCHANGED | ANCE | ANCE | ANCE | ANCE | ANCE | ANCE | ANCE |
| | | WATER | | | | | | | |
| | SOLID COMPONENT | | 8.50 | 8.50 | 21.00 | 22.00 | 8.50 | 8.50 | 8.50 |
| | (PIGMENT AND RESIN) | | | | | | | | |
| PARTICLE | ENTIRE INK | D50T [nm] | 73.33 | 63.30 | 69.50 | 68.60 | 394.0 | 647.4 | 68.23 |
| DIAMETER | (DISPERSION | | | | | | | | |
| EVALUATION | COMPONENT) | | | | | | | | |
| | PIGMENT | D50P [nm] | 65.31 | 65.31 | 65.31 | 65.31 | 403.4 | 701.4 | 65.31 |
| | DISPERSION | | | | | | | | |
| | RESIN | D50R [nm] | 204.6 | 31.20 | 79.10 | 79.10 | 79.10 | 79.10 | — |
| | PARTICLE | | | | | | | | |
| | DISPERSION | | | | | | | | |

| | | | | | | | | |
|---|---|---|---|---|---|---|---|---|
| | D50R/D50P[−] | 3.133 | 0.478 | 1.211 | 1.211 | 0.196 | 0.113 | — |
| EVALUATION | DISPERSION STABILITY | A | A | A | A | C | C | A |
| RESULT | EJECTION PERFORMANCE | A | A | A | A | C | C | A |
| | COLORATION | B | B | A | A | — | — | C |
| | ABRASION RESISTANCE | A/B | A/B | A/B | A/A | — | — | A/B |
| | (DRY/WET) | | | | | | | |
| | LIGHT RESISTANCE | B | B | B | B | — | — | B |
| | STORAGE STABILITY | B | B | B | B | B | B | A |

The components shown in Tables 1 and 2 are as follows.
pigment dispersion (1): pink fluorescent pigment dispersion (SF-3017, particle diameter: 65 mm, manufactured by Sinloihi Company, Limited)
pigment dispersion (2): pink fluorescent pigment dispersion (SF-5017, particle diameter: 130 mm, manufactured by Sinloihi Company, Limited)
pigment dispersion (3): pink fluorescent pigment dispersion (dispersion having a smaller particle diameter obtained by a filter treatment of SF-3017, followed by removing large particles, particle diameter: 40 mm, manufactured by Sinloihi Company, Limited)
pigment dispersion (4): pink fluorescent pigment dispersion (SF-8017, particle diameter: 400 mm, manufactured by Sinloihi Company, Limited)
pigment dispersion (5): pink fluorescent pigment dispersion (SW-117, particle diameter: 650 mm, manufactured by Sinloihi Company, Limited)
resin particle dispersion (1): Takelac W-6110 (manufactured by Mitsui Chemicals Inc.)
resin particle dispersion (2): Superflex 740 (manufactured by DKS Co., Ltd.)
resin particle dispersion (3): Superflex 800 (manufactured by DKS Co., Ltd.)
non-ionic resin particles: Superflex 500M (manufactured by DKS Co., Ltd.)
ultraviolet absorber: Shineguard TA-04 (manufactured by SENKA Corporation)
BYK-348: silicone-based surfactant (manufactured by BYK Japan KK)
BYK-028: silicone-based surfactant (manufactured by BYK Japan KK)
Emulgen: Emulgen 430 (manufactured by Kao Corporation)
EDTA: disodium ethylenediaminetetraacetate (reagent)
Proxel: Proxel XL-2 (manufactured by Lonza Japan)
BTA: benzotriazole (reagent)
KOH: potassium hydroxide (reagent)

In addition, in Tables 1 and 2, as the particle diameter evaluation, the volume average particle diameter (D50_{T}) of the dispersion component of the aqueous ink jet ink composition, the volume average particle diameter (D50_{P}) of the organic fluorescent pigment itself, the volume average particle diameter (D50_{R}) of the ionic resin particles, and a ratio of the volume average particle diameter (D50_{R}) of the ionic resin particles to the volume average particle diameter (D50_{P}) of the organic fluorescent pigment, that is, D50_{R}/D50_{P}, are shown. In addition, the volume average particle diameter of each dispersion was measured by a NanotracWave II-EX150 manufactured by MicrotracBEL Corp. using a sample obtained by diluting each dispersion with purified water to have an appropriate concentration.

### 3.2. Evaluation Method

The aqueous ink jet ink composition of each example was evaluated as described below. In addition, in the evaluation result shown in the table, the item represented by “-” indicates that the evaluation could not be performed.

### 3.2.1. Dispersion Stability

After the aqueous ink jet ink composition of each example received in a sample bottle was left for three hours, the degree of dispersion stability was observed by visual inspection and was then evaluated in accordance with the following criteria, and the results are shown in Tables 1 and 2. When the evaluation result was A, it was regarded that a preferable effect was obtained.

A: Since neither precipitation nor separation is observed, dispersion stability is superior.

C: Since precipitation and/or separation is observed, dispersion stability is inferior.

### 3.2.2. Formation of Printed Matter

By using an ink jet printer (trade name: “PX-G930”, manufactured by Seiko Epson Corporation), the aqueous ink jet ink composition of each example prepared as described above was adhered to a 100%-cotton cloth by an ink jet method. As recording conditions, a recording resolution, an ink mass, and a recording area were set to 1,440 dpiX720 dpi, 23 ng/dot, and an A4 size, respectively, and a printed matter in which a solid pattern image was formed on a cloth functioning as a recording medium was manufactured. In this case, the “solid pattern image” indicates an image in which a dot was recorded on every pixel which was a minimum recording unit region defined by the recording resolution. In addition, the printed matter was dried by a heating treatment at 160° C. for 8 minutes using an oven.

### 3.2.3. Ejection Performance

The ejection performance in printed-matter formation was evaluated in accordance with the following criteria, and the results are shown in Tables 1 and 2.

A: No nozzle missing occurs, and printing surface is uniformly printed without irregularities.

C: Nozzle missing occurs, and part of printing surface which is not dyed forms at least one line shape.

### 3.2.4. Coloration

An OD value of a printed cloth was measured using a fluorescent spectrodensitometer (“FD-7”, manufactured by Konica Minolta, Inc.), and the coloring property was evaluated. In accordance with the following evaluation criteria, the results are shown in Tables 1 and 2. When the evaluation result was B′ or higher, it was regarded that a preferable effect was obtained.

A: OD value of 0.55 or more

B: OD value of 0.53 to less than 0.55

B′: OD value of 0.50 to less than 0.53

C: OD value of less than 0.50

### 3.2.5. Abrasion Resistance

After wet and dry abrasion resistance tests were each performed on a cloth on which printing was performed at a duty of 100% in accordance with ISO105-X12 and were then evaluated by the following criteria, the results are shown in Tables 1 and 2.

A: Grade 3 or higher

B: Grade 2 to lower than Grade 3

C: Grade 1 or lower

### 3.2.6. Light Resistance

After a printed matter was set in a Xenon light resistance tester XL-75s (trade name, manufactured by Suga Test Instruments Co., Ltd.), an exposure test was performed for three days at 23° C., a relative humidity of 50%, and an illuminance of 25,000 lux. After an OD value (D0) of the printed matter thus obtained before the exposure and an OD value (D) thereof after the exposure were measured by a fluorescent spectrodensitometer (“FD-7”, manufactured by Konica Minolta, Inc.), a residual optical density rate (ROD) was obtained by the following equation, and the light resistance was evaluated in accordance with the following criteria. The results thus obtained are shown in Tables 1 and 2.

ROD (%)=(D/D0)×100

A: ROD of 70% or more

B: ROD of 50% to less than 70%

B′: ROD of 40% to less than 50%

C: ROD of less than 40%

### 3.2.7. Storage Stability

After a viscosity of the ink composition immediately after the preparation and a viscosity thereof after being left for seven days at 60° C. were measured by an viscoelastic tester MCR-300 (trade name, manufactured by Pysica), the rate of change therebetween was obtained. Evaluation was performed in accordance with the following criteria, and the results are shown in Tables 1 and 2.

A: Rate of change in viscosity is less than 5%.

B: Rate of change in viscosity is 5% to less than 10%.

C: Rate of change in viscosity is 10% or more.

### 3.2.8. Correlation Between Pigment Concentration and OD Value

The aqueous ink jet ink composition of Example 8 and three aqueous ink jet ink compositions in each of which only the content of the organic fluorescent pigment and the content of water were changed were formed. The contents of the organic fluorescent pigments of the aqueous ink jet ink compositions were 2.5 percent by mass, 3.5 percent by mass (Example 8), 6.0 percent by mass, and 8.0 percent by mass. By using those aqueous ink jet ink compositions described above, the OD value of the recorded matter formed in a manner similar to that of “3.2.2 Formation of printed matter” was measured using a fluorescent spectrodensitometer (“FD-7”, manufactured by Konica Minolta, Inc.), and as a result, OD values of 0.52, 0.54, 0.59, and 0.63 were obtained at contents of 2.5 percent by mass, 3.5 percent by mass (Example 8), 6.0 percent by mass, and 8.0 percent by mass, respectively.

### 3.3. Evaluation Results

As shown in Tables 1 to 2, in the aqueous ink jet ink composition of each Example in which the organic fluorescent pigment, the ionic resin particles, the water-soluble organic solvent, and water were included, and the volume average particle diameter (D50_{T}) of the dispersion component was 150.0 nm or less, the dispersion stability and the coloring property were both preferable. In the aqueous ink jet ink compositions of Comparative Examples 1 and 2 in each of which D50_{T} was more than 150.0 nm, the dispersion stability was inferior, and the coloring property could not be evaluated. In the aqueous ink jet ink composition of Comparative Example 3 in which the non-ionic resin particles were used, although the dispersion stability was preferable, the coloring property was inferior. One reason for this is believed that although the dispersion can be secured by the non-ionic resin particles, a function to enable the organic fluorescent pigment to stay around the surface of the cloth is weak, and the organic fluorescent pigment penetrates therein. In addition, from the results of “3.2.8. CORRELATION BETWEEN PIGMENT CONCENTRATION AND OD VALUE”, it was found that the pigment concentration and the OD value had a linear correlation.

The present disclosure is not limited to the embodiments described above and may be variously changed and/or modified. For example, the present disclosure includes substantially the same structure (such as the structure in which the function, the method, and the result are the same, or the structure in which the object and the effect are the same) as the structure described in the embodiment. In addition, the present disclosure includes the structure in which a nonessential portion of the structure described in the embodiment is replaced with something else. In addition, the present disclosure includes the structure which performs the same operational effect as that of the structure described in the embodiment or the structure which is able to achieve the same object as that of the structure described in the embodiment. In addition, the present disclosure includes the structure in which a known technique is added to the structure described in the embodiment.

What is claimed is:

1. An aqueous ink jet ink composition comprising:
an organic fluorescent pigment;
ionic resin particles;
a water-soluble organic solvent; and
water,
wherein the organic fluorescent pigment and the ionic resin particles are collectively regarded as a dispersion component, and
the dispersion component has a volume average particle diameter (D50_{T}) of 150.0 nm or less.

2. The aqueous ink jet ink composition according to claim 1, which is used for printing of a cloth.

3. The aqueous ink jet ink composition according to claim 1,
wherein a content of the organic fluorescent pigment with respect to a total mass of the composition is 3.0 percent by mass or more.

4. The aqueous ink jet ink composition according to claim 1,
wherein the dispersion component has a volume average particle diameter (D50_{T}) of 50.0 nm or more.

5. The aqueous ink jet ink composition according to claim 1,
wherein the organic fluorescent pigment has a volume average particle diameter (D50_{P}) of 50.0 to 150.0 nm.

6. The aqueous ink jet ink composition according to claim 1,
wherein (D50_{R})/(D50_{P}) is 0.5 to 1.5,
where (D50_{R}) represents a volume average particle diameter of the ionic resin particles, and (D50_{P}) represents a volume average particle diameter of the organic fluorescent pigment.

7. The aqueous ink jet ink composition according to claim 1,
wherein the organic fluorescent pigment integrally contains a fluorescent dye and a resin.

8. The aqueous ink jet ink composition according to claim 1, further comprising:
an ultraviolet absorber.

9. The aqueous ink jet ink composition according to claim 1,
wherein a content of the organic fluorescent pigment with respect to a total mass of the composition is 5.0 to 10.0 percent by mass.

10. The aqueous ink jet ink composition according to claim 1,
wherein a content of the ionic resin particles with respect to a total mass of the composition is 6.0 to 12.0 percent by mass.

11. The aqueous ink jet ink composition according to claim 1,
wherein a content of the dispersion component with respect to a total mass of the composition is 8.0 to 20.0 percent by mass.

12. An ink jet recording method comprising:
an ink adhesion step of ejecting an aqueous ink jet ink composition from a nozzle of an ink jet head to adhere to a recording medium,
wherein the aqueous ink jet ink composition includes an organic fluorescent pigment, ionic resin particles, a water-soluble organic solvent, and water,
the organic fluorescent pigment and the ionic resin particles are collectively regarded as a dispersion component, and
the dispersion component has a volume average particle diameter (D50_{T}) of 150.0 nm or less.
